(19) United States
(12) Patent Application Publication
(10) Pub. No.: US 2016/0000021 A1
(43) Pub. Date: Jan. 7, 2016

(54) CULTIVATION CONTROL SYSTEM, CULTIVATION CONTROL PROGRAM, AND CULTIVATION CONTROL METHOD

(71) Applicant: BRILLIANTSERVICE CO., LTD, Osaka-shi, Osaka (JP)

(72) Inventor: Yoshihiko Sugimoto, Osaka-shi, Osaka (JP)

(21) Appl. No.: 14/768,487

(22) PCT Filed: Feb. 19, 2013
(86) PCT No.: PCT/JP2013/000906

§ 371 Date: Aug. 18, 2015

(51) Int. Cl. A01G 9/24; A01G 7/04; A01G 1/00; A01C 21/00

(52) U.S. Cl. CPC A01G 9/24; A01C 21/00; A01G 7/045; A01G 1/001

(57) ABSTRACT

There are provided a cultivation control system, a cultivation control program, and a cultivation control method that can independently set growth conditions in a plurality of divided cultivation spaces and that can perform control by changing growth environments in the individual cultivation spaces. In a cultivation apparatus 300, each of the internal environments of a plurality of shielded spaces is shielded from the internal environments of the shielded spaces adjacent thereto and from an external environment of the cultivation apparatus 300. A portable communication communication terminal 200 performs remote control of environment control apparatuses 350a to 350f such that at least one of the internal environments of the plurality of shielded spaces is independently controlled.

### TECHNICAL FIELD

The present invention relates to a cultivation control system, a cultivation control program, and a cultivation control method for a cultivation apparatus for growing plants such as vegetables, fruits, and flowers.

### BACKGROUND ART

Conventionally, a wide variety of experiments and studies have been performed for cultivation apparatuses. JP 2012-39996 A (Patent Literature 1) discloses a plant cultivation system that artificially controls a cultivation environment and includes light sources that perform both growth and observation.

The plant cultivation system described in Patent Literature 1 is a plant cultivation system that cultivates a plant indoors and includes a cultivation cell which is a divided space for cultivating the plant, and managing means for managing the cultivation of the plant. The cultivation cell includes a cultivation rack which is a movable rack for cultivating the plant, and light-blocking means for blocking entry of sunlight into the divided space. The cultivation rack includes a cultivation shelf for cultivating the plant, and light control means for controlling a light with which the plant is irradiated. The cultivation shelf includes a light source that irradiates the plant with a light under control of the light control means by adjusting an amount of irradiation from a light emitter module having a plurality of light-emitting diodes, and observing means for observing the plant under the irradiation from the light emitter module to obtain observation data, and transmitting the obtained observation data to the managing unit. The light emitter module includes a first light-emitting diode that emits a light with a first spectrum; m (m is an integer greater than or equal to 2) second light-emitting diodes that are disposed on a circumference of a first circle having the first light-emitting diode at a center and that emit a light with a second spectrum; and n (n is an integer greater than or equal to 2) third light-emitting diodes that are disposed on a circumference of a second circle having the first light-emitting diode at a center and that emit a light with a third spectrum. The first spectrum, the second spectrum, and the third spectrum differ from one another. The second light-emitting diodes are disposed so as to be equal in number to n arcs of the first circle divided by rays passing through the third light-emitting diodes, respectively, with the first light-emitting diode defined as a starting point. The managing means includes receiving means for obtaining the observation data from the observing means, a library that records the observation data obtained by the receiving means, and computing means for estimating a harvest date of the plant by comparing the observation data obtained by the receiving means with past observation data of a plant of a same species as the plant recorded in the library.

### CITATION LIST

### Patent Literature

Patent Literature 1: JP 2012-39996 A

### SUMMARY OF THE INVENTION

### Technical Problem

Patent Literature 1 also describes that a plurality of cultivation cells may be provided in the cultivation system to set different cultivation environments for different cultivation cells. However, setting different cultivation environments for different cultivation cells in the cultivation system of Patent Literature 1 specifically indicates irradiation of each of the completely light-blocked cultivation cells with a predetermined light. Specifically, it merely determines that one cultivation cell is irradiated with only a red light, another cultivation cell is irradiated with a red light and a blue light, and still another cultivation cell is irradiated with a red light, a blue light, and a white light (which may be a green light). That is, a light irradiation environment in each cultivation cell is fixed and thus cannot be changed. In order that different growth conditions under which a plant is placed are provided for different growth stages, plants with different growth stages need to be moved between different cultivation cells set with different irradiation environments which are thus fixed. That is, plants cannot be controlled in the same cultivation cell.

The present invention is developed in view of such a conventional art problem. An object of the present invention is therefore to provide a cultivation control system, a cultivation control program, and a cultivation control method that can independently set growth conditions in a plurality of divided cultivation spaces and that can perform control by changing growth environments in the individual cultivation spaces.

### Solution to Problem

(1)

A cultivation control system according to one aspect includes a cultivation apparatus and a communication terminal. The cultivation apparatus includes a plurality of shielded spaces for growing plants, and environment control apparatuses for controlling growth conditions in internal environments of the shielded spaces.

In the cultivation apparatus, each of the internal environments of the plurality of shielded spaces is shielded from an internal environment of a shielded space adjacent thereto and from an external environment of the cultivation apparatus.

The communication terminal performs remote control of the environment control apparatuses such that at least one of the internal environments of the plurality of shielded spaces is independently controlled.

In this case, by means of the communication terminal, a user can grow a plant in a specific partitioned space among a plurality of partitioned spaces provided in the cultivation apparatus present at a distant location. Since the inside of the partitioned space to be controlled is shielded from external environmental factors, the plant to be grown in the partitioned space is efficiently placed under a controlled condition.

Note that the expression “a space is shielded” refers to that the space is isolated from other spaces than the space (i.e., an adjacent shielded space and an external space of the cultivation apparatus) so that a component to be controlled which is present in an internal environment of the space can be present under a different condition from that for the component to be controlled which is present in the other spaces.

In addition, the term “remote” indicates that a connection is not established by a cable and the like. In particular, the term “remote” indicates that a connection is established through the Internet or a cloud.

(2)

A cultivation control system according to a second invention may be configured as follows. In the cultivation control system according to the one aspect, the growth conditions to be controlled may be a concentration of carbon dioxide.

In this case, the rates of photosynthesis and respiration can be adjusted.

(3)

A cultivation control system according to a third invention may be configured as follows. In the cultivation control system according to the second invention, the environment control apparatuses may control one of pressure and a flow rate from a carbon dioxide storage tank that stores carbon dioxide emitted from a carbon dioxide emitting source in the external environment.

In this case, carbon dioxide that is produced in the external environment and stored can be effectively and easily used as a raw material of photosynthesis, from the carbon dioxide storage tank. As a result, cost reduction and recycling effect can be enhanced.

Note that the carbon dioxide emitting source may be biomass or non-biomass (specifically, industrial waste).

(4)

A cultivation control system according to a fourth invention may be configured as follows. In the cultivation system according to the first aspect to the third invention, the growth conditions to be controlled may be at least one of an amount and a composition of liquid fertilizer.

In this case, the amount and/or composition of liquid fertilizer can be adjusted.

Note that the liquid fertilizer may be an organic liquid fertilizer (specifically, a mixture of biomass-derived nitrogen, phosphorus, and potassium and an active organic component) or may be an inorganic liquid fertilizer (specifically, a mixture of inorganic components including nitrogen, phosphorus, and potassium).

(5)

A cultivation control system according to a fifth invention may be configured as follows. In the cultivation control system according to the fourth invention, the environment control apparatuses may control at least one of pressure and a flow rate from a liquid fertilizer storage tank that stores biogas liquid fertilizer derived from biomass in the external environment.

In this case, a product produced from biomass in the external environment can be effectively used as liquid fertilizer by recycling.

(6)

A cultivation control system according to a sixth invention may be configured as follows. In the cultivation control system according to the one aspect to the fifth invention, the growth conditions to be controlled may be at least one of humidity and temperature, and the environment control apparatuses may be air conditioners.

In this case, any one of humidity and temperature, only humidity, and only temperature can be adjusted by the air conditioners.

(7)

A cultivation control system according to a seventh invention may be configured as follows. In the cultivation control system according to the one aspect to the sixth invention, the environment control apparatuses may be lighting apparatuses. The growth conditions to be controlled may be at least one of dominant wavelength and brightness level of a light from the lighting apparatuses.

In this case, the dominant wavelength and brightness level of the light from the lighting apparatuses, only the brightness level, or only the dominant wavelength can be controlled. Thus, the plants can be grown more efficiently.

(8)

A cultivation control system according to an eighth invention may be configured as follows. In the cultivation control system according to the seventh invention, the lighting apparatuses may include a light source of at least one of a light-emitting diode element and an organic electroluminescent element.

In this case, by using a light-emitting diode device and an organic electroluminescent device, a reduction in power consumption can be achieved, and use for a long period of time is possible. As a result, energy saving and lifespan extension can be achieved.

(9)

A cultivation control system according to a ninth invention may be configured as follows. In the cultivation control system according to the seventh or eighth invention, the lighting apparatuses each may include: a plurality of types of light sources that emit light of different dominant wavelengths; and a plurality of boards having the plurality of types of light sources provided thereon, and each of the boards may be extendable by being coupled to the other one of the boards.

In this case, irradiation with a plurality of light of different dominant wavelengths and/or different brightness levels is possible. As a result, the dominant wavelength of the light to be irradiated and the brightness level of the light to be irradiated can be adjusted depending on the species of a plant and the growth time.

(10)

A cultivation control system according to a tenth invention may be configured as follows. In the cultivation control system according to the one aspect to the ninth invention, the growth conditions to be controlled may be at least one of a concentration of nitrogen, a concentration of oxygen, liquid pressure, gas pressure, a liquid flow, and a gas flow.

In this case, the rate of plant's growth response which is affected by at least one of the concentration of nitrogen, the concentration of oxygen, the liquid pressure, the gas pressure, the liquid flow, and the gas flow can be adjusted. Note that the concentration of oxygen includes at least one of the concentration of oxygen in air and the concentration of oxygen included in a liquid.

(11)

A cultivation control system according to an eleventh invention may be configured as follows. The cultivation control system according to the one aspect to the tenth invention may further include a dosimeter that measures a dose of a radioactive material in the internal environments or at a part that can contact or communicate with the internal environments.

In this case, the influence of a radioactive material on a plant to be cultivated can be monitored.

(12)

A cultivation control system according to a twelfth invention may be configured as follows. The cultivation control system according to the eleventh invention may further include at least one of a notification apparatus that provides notification when the dose of the radioactive material exceeds a threshold value, and a recording apparatus that records the dose.

In this case, whether a plant to be cultivated is contaminated with a radioactive material can be easily known.

Note that a notification destination may be a communication terminal of a user who is a cultivator or may be a communication terminal of an outside system administrator other than the cultivator.

(13)

A cultivation control system according to a thirteenth invention may be configured as follows. The cultivation control system according to the one aspect to the twelfth invention may further include an electric power receiving apparatus that receives electric power from a biomass power generating apparatus, using biomass in the external environment.

In this case, biomass in the external environment can be effectively used as an electric power source by recycling.

(14)

A cultivation control system according to a fourteenth invention may be configured as follows. In the cultivation control system according to the one aspect to the thirteenth invention, the remote control may be performed through a cloud.

In this case, by passing through a cloud, multiple control instructions can be easily processed.

(15)

A cultivation control system according to a fifteenth invention may be configured as follows. The cultivation control system according to the one aspect to the fourteenth invention may further include a notification apparatus that provides notification when any of the growth conditions deviates from a reference range.

In this case, the growth conditions to be controlled can be easily adjusted and maintained within a predetermined range. In addition, since notification is provided when any of the growth conditions deviates, easy recognition is possible.

(16)

A cultivation control system according to a sixteenth invention may be configured as follows. The cultivation control system according to the one aspect to the fifteenth invention may further include a recording apparatus for recording the growth conditions.

In this case, a history of the growth conditions can be saved. As a result, when a growth condition needs to be checked again, the growth condition can be easily checked.

Note that the recording apparatus may be present in a cloud or may be separately composed of an Internet-connectable recording apparatus.

(17)

A cultivation control program according to another aspect includes: an environment control process that controls growth conditions of plants in internal environments of a plurality of shielded spaces; and a remote control process that independently controls the environment control process for at least one of the internal environments of the plurality of shielded spaces.

In the cultivation control program according to the present invention, the growth conditions of the plants in the internal environments of the plurality of shielded spaces are controlled by the environment control process, and the environment control process for at least one of the internal environments of the plurality of shielded spaces is independently controlled by the remote control process

In this case, a user can grow a plant in a specific partitioned space among a plurality of partitioned spaces provided in a cultivation apparatus present at a distant location. Since the inside of the partitioned space to be controlled is shielded from external environmental factors, the plant to be grown in the partitioned space is efficiently placed under a controlled condition.

(18)

A cultivation control program according to an eighteenth invention may be configured as follows. In the cultivation control program according to the another aspect, the environment control process may further include a carbon dioxide control procedure that controls one of pressure and a flow rate from a carbon dioxide storage tank that stores carbon dioxide emitted from a carbon dioxide emitting source in the external environment.

In this case, carbon dioxide that is produced in the external environment and stored can be effectively and easily used as a raw material of photosynthesis, from the carbon dioxide storage tank. As a result, cost reduction and recycling effect can be enhanced.

Note that the carbon dioxide emitting source may be biomass or non-biomass (specifically, industrial waste).

(19)

A cultivation control program according to a nineteenth invention may be configured as follows. In the cultivation control program according to the another aspect or the eighteenth invention, the environment control process may further include a liquid fertilizer control process that controls one of pressure and a flow rate from a liquid fertilizer storage tank that stores biogas liquid fertilizer derived from biomass in the external environment.

In this case, the amount and/or composition of liquid fertilizer can be adjusted.

Note that the liquid fertilizer may be an organic liquid fertilizer (specifically, a mixture of biomass-derived nitrogen, phosphorus, and potassium and an active organic component) or may be an inorganic liquid fertilizer (specifically, a mixture of inorganic components including nitrogen, phosphorus, and potassium).

(20)

A cultivation control program according to a twentieth invention may be configured as follows. In the cultivation control program according to the another aspect and the eighteenth and nineteenth inventions, the environment control process may further include an air-conditioning process that controls at least one of humidity and temperature.

In this case, any one of humidity and temperature, only humidity, and only temperature can be adjusted by air conditioners.

(21)

A cultivation control program according to a twenty-first invention may be configured as follows. In the cultivation control program according to the another aspect and the eighteenth to twentieth inventions, the environment control process may further include a lighting control process that controls lighting apparatuses.

In this case, the dominant wavelength and brightness level of the light from the lighting apparatuses, only the brightness level, or only the dominant wavelength can be controlled. Thus, the plants can be grown more efficiently. Furthermore, when the lighting apparatus is composed of a plurality of types, control can be performed by the individual types.

(22)

A cultivation control program according to a twenty-second invention may be configured as follows. In the cultivation control program according to the another aspect and the eighteenth to twenty-first inventions, the environment control process may control at least one of a concentration of nitrogen, a concentration of oxygen, liquid pressure, gas pressure, a liquid flow, and a gas flow.

In this case, the rate of plant's growth response which is affected by at least one of the concentration of nitrogen, the concentration of oxygen, the liquid pressure, the gas pressure, the liquid flow, and the gas flow can be adjusted. Note that the concentration of oxygen includes at least one of the concentration of oxygen in air and the concentration of oxygen included in a liquid.

(23)

A cultivation control program according to a twenty-third invention may be configured as follows. The cultivation control program according to the another aspect to the twenty-second invention may further include a recording process for recording the controlled growth conditions.

In this case, a history of the growth conditions can be saved. As a result, when a growth condition needs to be checked again, the growth condition can be easily checked.

Note that the recording process may support a cloud or may be an Internet-connectable recording process.

(24)

A cultivation control method according to still another invention includes: an environment controlling step of controlling growth conditions of plants in internal environments of a plurality of shielded spaces; and a remote controlling step of independently controlling the environment controlling step for at least one of the internal environments of the plurality of shielded spaces.

In the cultivation control method according to the present invention, the growth conditions of the plants in the internal environments of the plurality of shielded spaces are controlled by the environment controlling step, and the environment controlling step for at least one of the internal environments of the plurality of shielded spaces is independently controlled by the remote controlling step.

In this case, a user can grow a plant in a specific partitioned space among a plurality of partitioned spaces provided in a cultivation apparatus present at a distant location. Since the inside of the partitioned space to be controlled is shielded from external environmental factors, the plant to be grown in the partitioned space is efficiently placed under a controlled condition.

(25)

A cultivation control method according to a twenty-fifth invention may be configured as follows. In the cultivation control method according to the still another aspect, the environment controlling step may include a carbon dioxide controlling step of controlling one of pressure and a flow rate from a carbon dioxide storage tank that stores carbon dioxide emitted from a carbon dioxide emitting source in the external environment.

In this case, carbon dioxide that is produced in the external environment and stored can be effectively and easily used as a raw material of photosynthesis, from the carbon dioxide storage tank. As a result, cost reduction and recycling effect can be enhanced.

Note that the carbon dioxide emitting source may be biomass or non-biomass (specifically, industrial waste).

(26)

A cultivation control method according to a twenty-sixth invention may be configured as follows. In the cultivation control method according to the still another aspect or the twenty-fifth invention, the environment controlling step may further include a liquid fertilizer controlling step of controlling one of pressure and a flow rate from a liquid fertilizer storage tank that stores biogas liquid fertilizer derived from biomass in the external environment.

In this case, the amount and/or composition of liquid fertilizer can be adjusted.

Note that the liquid fertilizer may be an organic liquid fertilizer (specifically, a mixture of biomass-derived nitrogen, phosphorus, and potassium and an active organic component) or may be an inorganic liquid fertilizer (specifically, a mixture of inorganic components including nitrogen, phosphorus, and potassium).

(27)

A cultivation control method according to a twenty-seventh invention may be configured as follows. In the cultivation control method according to the still another aspect to the twenty-sixth invention, the environment controlling step may further include an air-conditioning step of controlling at least one of humidity and temperature.

In this case, any one of humidity and temperature, only humidity, and only temperature can be adjusted by air conditioners.

(28)

A cultivation control method according to a twenty-eighth invention may be configured as follows. In the cultivation control method according to the still another aspect to the twenty-seventh invention, the environment controlling step may further include a lighting controlling step of controlling lighting apparatuses.

In this case, the dominant wavelength and brightness level of the light from the lighting apparatuses, only the brightness level, or only the dominant wavelength can be controlled. Thus, the plants can be grown more efficiently. Furthermore, when the lighting apparatus is composed of a plurality of types, control can be performed by the individual types.

(29)

A cultivation control method according to a twenty-ninth invention may be configured as follows. In the cultivation control method according to the still another aspect to the twenty-eighth invention, the environment control process may control at least one of a concentration of nitrogen, a concentration of oxygen, liquid pressure, gas pressure, a liquid flow, and a gas flow.

In this case, the rate of plant's growth response which is affected by at least one of the concentration of nitrogen, the concentration of oxygen, the liquid pressure, the gas pressure, the liquid flow, and the gas flow can be adjusted. Note that the concentration of oxygen includes at least one of the concentration of oxygen in air and the concentration of oxygen included in a liquid.

(30)

A cultivation control method according to a thirtieth invention may be configured as follows. The cultivation control method according to the still another aspect to the twenty-ninth invention may further include a recording process for recording the controlled growth conditions.

In this case, a history of the growth conditions can be saved. As a result, when a growth condition needs to be checked again, the growth condition can be easily checked.

Note that the recording process may support a cloud or may be an Internet-connectable recording process.

### Advantageous Effect of the Invention

According to the present invention, a cultivation control system, a cultivation control program, and a cultivation control method can be provided that can independently set growth conditions in a plurality of divided cultivation spaces and that can perform control by changing growth environments in the individual cultivation spaces.

### BRIEF DESCRIPTION OF THE DRAWINGS

FIG. 1 is a schematic diagram for describing a configuration of a basic outline of a cultivation system according to one embodiment.

FIG. 2 is a schematic diagram for describing an overall outline of the cultivation system of FIG. 1.

FIG. 3 is a schematic diagram showing an example of a display screen of a portable communication terminal.

FIG. 4 is a schematic diagram showing an example of a cultivation apparatus.

FIG. 5 is a partially enlarged view showing an example of lighting apparatuses of the cultivation apparatus.

FIG. 6 is a flowchart showing an example of control of the cultivation system.

FIG. 7 is a schematic diagram showing an example of the display screen of the portable communication terminal.

FIG. 8 is a schematic diagram showing another example of the display screen of the portable communication terminal.

FIG. 9 is a schematic diagram showing another example of the display screen of the portable communication terminal.

FIG. 10 is a flowchart showing an example of the operation of a biomass power generating apparatus.

FIG. 11 is a flowchart showing an example of the operation of an environment control apparatus.

FIG. 12 is a flowchart showing an example of the operation of a radioactivity detection apparatus.

### REFERENCE SIGNS LIST

100 cultivation system

200 communication terminal apparatus

300 cultivation apparatus

320a to 320f lighting apparatus

340a to 340f cultivation cell

350a to 350f environment control apparatus

351 carbon dioxide tank

361 liquid fertilizer storage tank

370 radioactivity detection apparatus

380 biomass power generating apparatus

390 notification apparatus

400 recording apparatus

500 cloud

### DESCRIPTION OF EMBODIMENTS

### First Embodiment

An embodiment of the present invention will be described below with reference to the drawings. In the following description, the same components are denoted by the same reference signs. Their names and functions are also the same. Therefore, a detailed description thereof is not repeated.

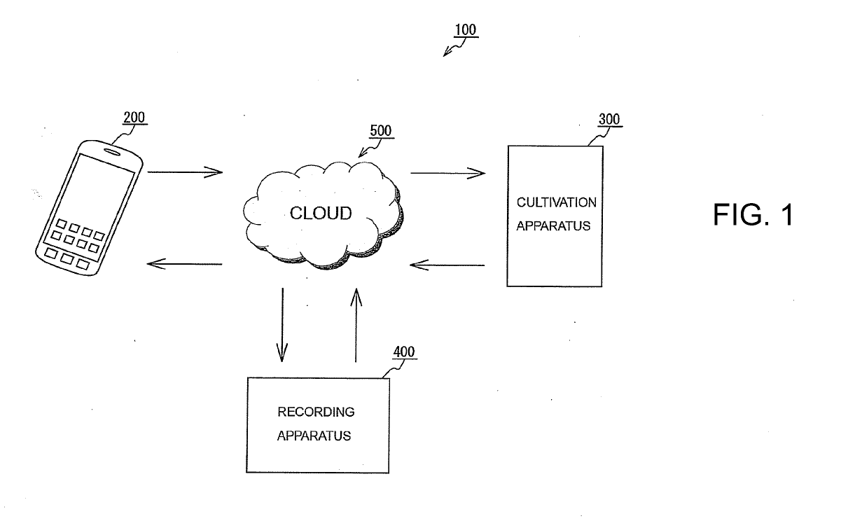

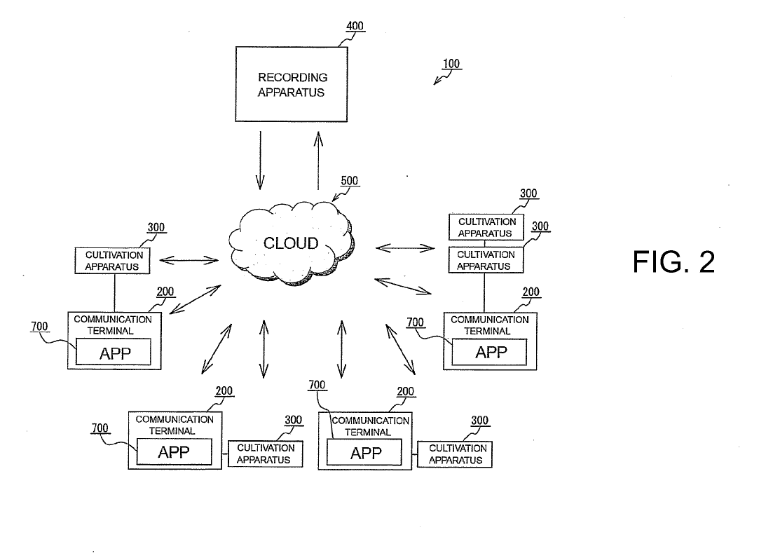

FIG. 1 is a schematic diagram for describing a configuration of a basic outline of a cultivation system 100 according to one embodiment, and FIG. 2 is a schematic diagram for describing an overall outline of the cultivation system 100 of FIG. 1.

As shown in FIG. 1, the cultivation system 100 includes a portable communication terminal 200, a cultivation apparatus 300, and a recording apparatus 400.

As shown in FIG. 1, the portable communication terminal 200 provides a control instruction to the cultivation apparatus 300 through a cloud 500. The cultivation apparatus 300 controls various types of devices provided in the cultivation apparatus 300, in accordance with the instruction from the portable communication terminal 200. The details of the various types of devices will be described later.

The cultivation apparatus 300 provides an operating status to the portable communication terminal 200 and records history information (hereinafter, abbreviated as “growth history information”) such as operations performed in response to control instructions, in the recording apparatus 400 whenever necessary.

Note that, although FIG. 1 exemplifies the portable communication terminal 200, the configuration is not limited thereto and any other device such as a tablet terminal that is communicable through the cloud 500 may be used.

In addition, although FIG. 1 explicitly shows, to help understanding, the case of growing in one cultivation apparatus 300, in practice, in the present invention, as shown in FIG. 2, in the cultivation system 100, multiple combinations of a portable communication terminal 200 of a user and one or a plurality of cultivation apparatuses 300 owned by the user are connected.

In addition, the portable communication terminal 200 is configured to have application software (also referred to as an application program; hereinafter, simply abbreviated as an app) 700 installed thereon so that the user can directly control the cultivation apparatus 300.

As described above, in the present invention, by using the cloud 500, shared information of multiple users can be collected and viewed.

### (Portable Communication Terminal)

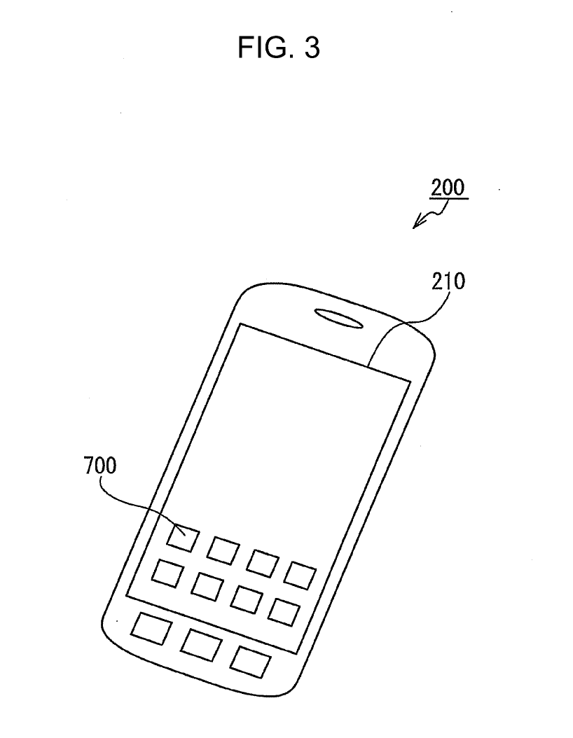

FIG. 3 is a schematic diagram showing an example of a display screen of the portable communication terminal 200.

As shown in FIG. 3, the portable communication terminal 200 is composed of a smartphone. In addition, the portable communication terminal 200 has an app 700 thereon. The app 700 is, as described above, composed of control software that can allow direct control of the cultivation apparatus 300.

The user installs and uses the app 700 on the portable communication terminal 200. As shown in FIG. 3, the app 700 is displayed as an icon on a display screen 210. Note that a specific example of control of each device in the cultivation apparatus 300 will be described later.

### (Cultivation Apparatus)

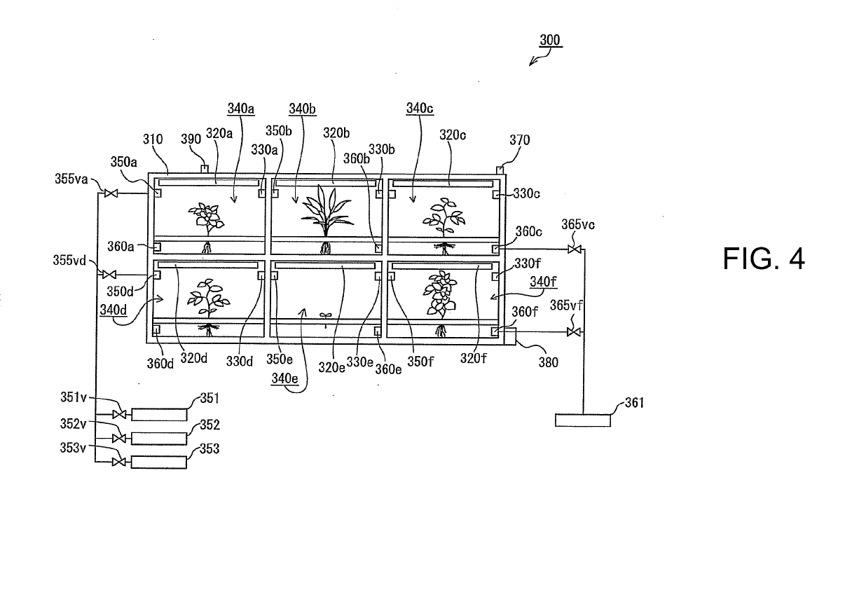

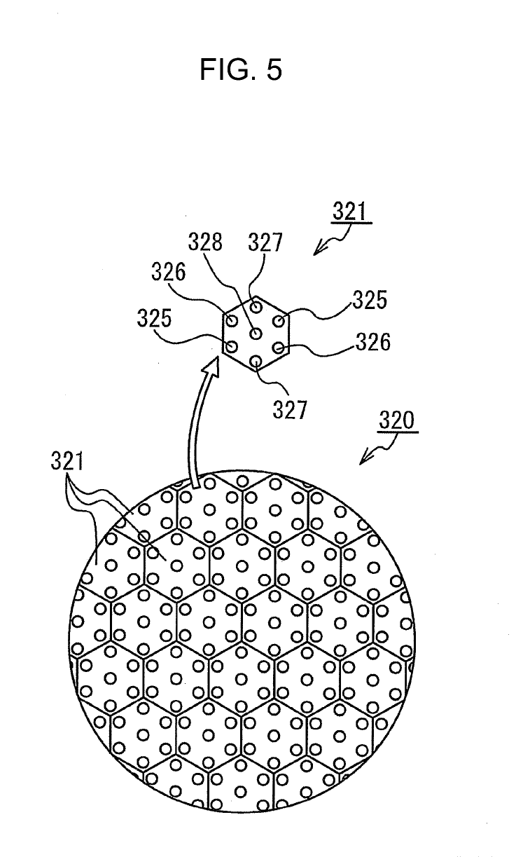

FIG. 4 is a schematic diagram showing an example of the cultivation apparatus 300, and FIG. 5 is a partially enlarged view showing an example of lighting apparatuses 320a to 320f of the cultivation apparatus 300.

As shown in FIG. 4, the cultivation apparatus 300 includes a frame body 310, the lighting apparatuses 320a to 320f, imaging apparatuses 330a to 330f, cultivation cells 340a to 340f, environment control apparatuses 350a to 350f, fertilizer supply control apparatuses 360a to 360f, a radioactivity detection apparatus 370, a biomass power generating apparatus 380, and a notification apparatus 390.

As shown in FIG. 4, the cultivation apparatus 300 is divided by the frame body 310 into a total of the six cultivation cells 340a to 340f, three each on top and bottom, and the internal space of each of the cultivation cells 340a to 340f is shielded from the internal spaces of its adjacent cultivation cells. Namely, a shielded space is formed inside each of the cultivation cells 340a to 340f. In the present embodiment, the frame body 310 of the cultivation apparatus 300 has a structure that hermetically seals the internal space of each of the six cultivation cells 340a to 340f.

### (Lighting Apparatus)

As shown in FIG. 4, the lighting apparatuses 320a to 320f are provided at the top of the internal spaces of the six cultivation cells 340a to 340f, respectively. FIG. 5 shows an example of the lighting apparatuses 320a to 320f (in the following, the lighting apparatuses 320a to 320f are collectively referred to as the lighting apparatuses 320). As shown in FIG. 5, each lighting apparatus 320 has a structure where a plurality of hexagonal lighting units 321 are assembled together. In the present embodiment, electricity is supplied to each unit 321 by a daisy-chain connection.

In addition, red light-emitting diodes (hereinafter, abbreviated as LEDs) 325, blue LEDs 326, infrared LEDs 327, and a white LED 328 are disposed in each of the hexagonal lighting units 321.

Specifically, as shown in FIG. 5, the white LED 328 is disposed at the center of the hexagon, and the red LEDs 325, the blue LEDs 326, and the infrared LEDs 327 are disposed in turn near the respective six vertices.

Note that although in the present embodiment the hexagonal lighting unit 321 is exemplified, the shape of the lighting unit 321 is not limited thereto and may be a triangle, a rectangle, a pentagon, an octagon, other polygons, or any other shape. Note also that although in the present embodiment the lighting apparatus 320 is formed of only the hexagonal lighting units 321, the lighting units 321 forming the lighting apparatus 320 do not need to be of one type, and lighting units 321 having two or more types of shapes may be combined together.

In addition, in the present embodiment, in the lighting apparatus 320, all sides of a hexagon of one lighting unit 321 butt against the sides of other lighting units 321 adjacent thereto, by which the lighting units 321 are combined together in a mode where their surfaces are two-dimensionally extended. By this, the lighting apparatus 320 as a whole has a flat shape. However, the shape of the lighting apparatus 320 is not limited to this mode and can be any shape that results from a combination of the shapes of the lighting units 321.

In addition, for example, lighting units 321 having two or more different types of shapes may be combined together, by which the lighting units 321 may be combined together in a mode where their surfaces are three-dimensionally extended. By this, the lighting apparatus 320 as a whole can have a polyhedral shape.

Furthermore, although in the present embodiment each of the cultivation cells 340a to 340f has one identical-shaped lighting apparatus 320 disposed therein, the configuration is not limited thereto, and lighting apparatuses 320 of different shapes and/or a different number of lighting apparatuses 320 may be employed in keeping with the cultivation cells 340a to 340f.

Note that although in the present embodiment the connection form of the hexagonal lighting units 321 is a daisy-chain connection, the configuration is not limited thereto and may be, for example, a star connection, or may be a connection form which is a combination of those connections, or may be any other connection form.

### (Imaging Apparatus)

In addition, as shown in FIG. 4, in the present embodiment, the imaging apparatuses 330a to 330f are respectively disposed in the six shielded spaces which are formed by the frame body 310. The imaging apparatuses 330a to 330f include video cameras, digital cameras, and the like.

The imaging apparatuses 330a to 330f each capture plant growth conditions continuously or intermittently at a predetermined interval by a CCD image sensor included therein.

Image data captured by the imaging apparatuses 330a to 330f is recorded in the recording apparatus 400 through the cloud 500 shown in FIG. 1.

### (Environment Control Apparatus)

As shown in FIG. 4, in the present embodiment, the environment control apparatuses 350a to 350f are respectively provided in the six cultivation cells 340a to 340f which are partitioned by the frame body 310.

The environment control apparatuses 350a to 350f include thermometers, hygrometers, liquid manometers, gas manometers, water temperature gauges, water heaters, heaters, humidification apparatuses, dehumidification apparatuses, and the like.

Furthermore, the six environment control apparatuses 350a to 350f are connected to a carbon dioxide tank 351, a nitrogen tank 352, and an oxygen tank 353 by piping. The piping is configured such that different amounts of gas can be supplied to the internal spaces of the cultivation cells 340a to 340f.

The piping has valves 351v, 352v, 353v, 355va, 355vb (not shown), 355vc (not shown), 355vd, 355ve (not shown), and 355vf (not shown) disposed therein. The valves 351v, 352v, and 353v are disposed to control the supply of gas from the inside of the carbon dioxide tank 351, the nitrogen tank 352, and the oxygen tank 353, respectively. The valves 355va, 355vb (not shown), 355vc (not shown), 355vd, 355ve (not shown), and 355vf (not shown) are disposed to control the supply of gas to the cultivation cells 340a to 340f, respectively.

In addition, as shown in FIG. 4, the communication terminal apparatus 200 can instruct the degree of opening and closing of each of the valves 351v, 352v, and 353v and the degrees of opening and closing of the valves 355va, 355vb (not shown), 355vc (not shown), 355vd, 355ve (not shown), and 355vf (not shown). In this case, the communication terminal apparatus 200 can activate only specific valves (e.g., the valves 351v and 355va when controlling the concentration of carbon dioxide within the cultivation cell 340a) among the valves 351v, 352v, 353v and 355va to 355vf. In this manner, the internal environment (e.g., the concentration of carbon dioxide) of a specific cultivation cell (e.g., the cultivation cell 340a) can be independently controlled.

Therefore, the communication terminal 200 individually controls the environment of at least one of the internal spaces of the cultivation cells 340a to 340f.

### (Fertilizer Supply Control Apparatus)

As shown in FIG. 4, the fertilizer supply control apparatuses 360a to 360f each control the amount and/or composition of liquid fertilizer. For example, biogas liquid fertilizer is controlled based on data from a nourishment measuring apparatus. A liquid fertilizer storage tank 361 has the biogas liquid fertilizer stored therein.

The six fertilizer supply control apparatuses 360a to 360f are connected to the liquid fertilizer storage tank 361 by piping. The piping is configured such that different amounts and/or different compositions of liquid fertilizer can be supplied to the internal spaces of the cultivation cells 340a to 340f, respectively.

The piping has valves 365va (not shown), 365vb (not shown), 365vc, 365vd (not shown), 365ve (not shown), and 365vf disposed therein. The valves 365va to 365vf are disposed to control the supply of liquid fertilizer to the cultivation cells 340a to 340f, respectively, respectively.

For example, as shown in FIG. 4, the communication terminal apparatus 200 can instruct the degrees of opening and closing of the valves 365va (not shown), 365vb (not shown), 365vc, 365vd (not shown), 365ve (not shown), and 365vf. In this case, the communication terminal apparatus can activate only a specific valve (e.g., the valve 365vc when controlling the concentration of liquid fertilizer within the cultivation cell 340c) among the valves 365va to 365vf. In this manner, the internal environment (specifically, the concentration of liquid fertilizer) of a specific cultivation cell (e.g., the cultivation cell 340c) can be independently controlled.

Therefore, the communication terminal 200 individually controls the environment of at least one of the internal spaces of the cultivation cells 340a to 340f.

### (Radioactivity Detection Apparatus)

The radioactivity detection apparatus 370 shown in FIG. 4 measures and detects radioactivity in the surrounding environment of the cultivation apparatus 300. In addition, the arrangement mode of the radioactivity detection apparatus 370 is not limited thereto, and the radioactivity detection apparatus 370 may be separately provided in each of the six cultivation cells 340a to 340f so that radioactivity in the six cultivation cells 340a to 340f can be measured and detected.

### (Biomass Power Generating Apparatus)

The biomass power generating apparatus 380 generates electric power, using biomass in an external environment. The electric power generated by the biomass power generating apparatus 380 is supplied to the lighting apparatuses 320a to 320f, the imaging apparatuses 330a to 330f, the environment control apparatuses 350a to 350f, the fertilizer supply control apparatuses 360a to 360f, the radioactivity detection apparatus 370, and the notification apparatus 390.

### (Notification Apparatus)

The notification apparatus 390 outputs notification information when an abnormal state occurs in any of the environments of the six cultivation cells 340a to 340f.

Here, the notification apparatus 390 may be embodied as an apparatus that transmits a notification signal appealing to human senses (represented as sight, hearing, and touch) to, for example, the portable communication terminal 200 that controls a cultivation cell which is a notification target, or may be embodied as a speaker, a vibration apparatus, a display unit, or the like, disposed on the cultivation apparatus 300 itself.

### (Recording Apparatus)

The recording apparatus 400 according to the present embodiment records growth history information including at least all of various types of instruction information from the portable communication terminal 200, image data captured by the imaging apparatuses 330a to 330f, and various types of control information and operating information of the environment control apparatuses 350a to 350f.

In addition, in the present embodiment, the recording apparatus 400 is present in the cloud 500. Note that although in the present embodiment the recording apparatus 400 is provided in the cloud 500, the configuration is not limited thereto and the recording apparatus 400 may be a recording apparatus that is communicable through the cloud 500.

### (Basic Program for the Cultivation System)

Next, an outline of the operation of the cultivation system will be described.

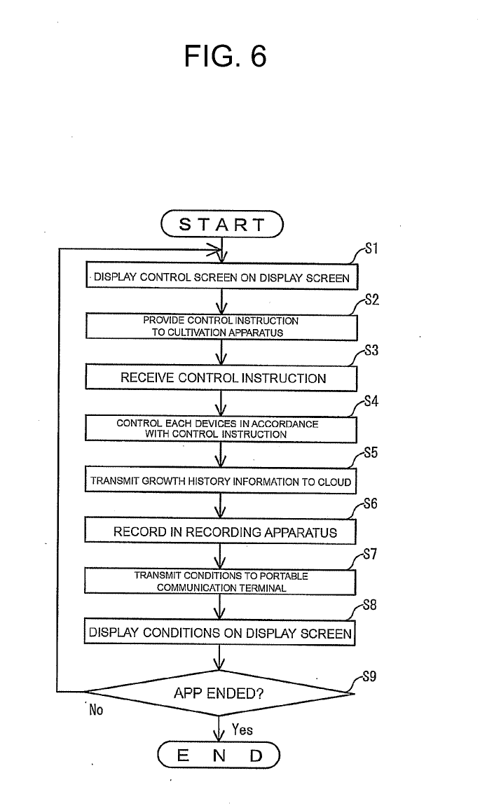

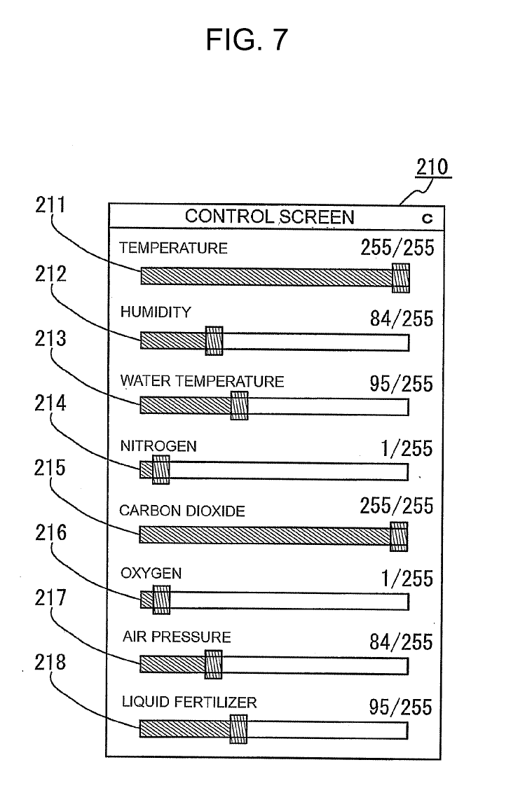

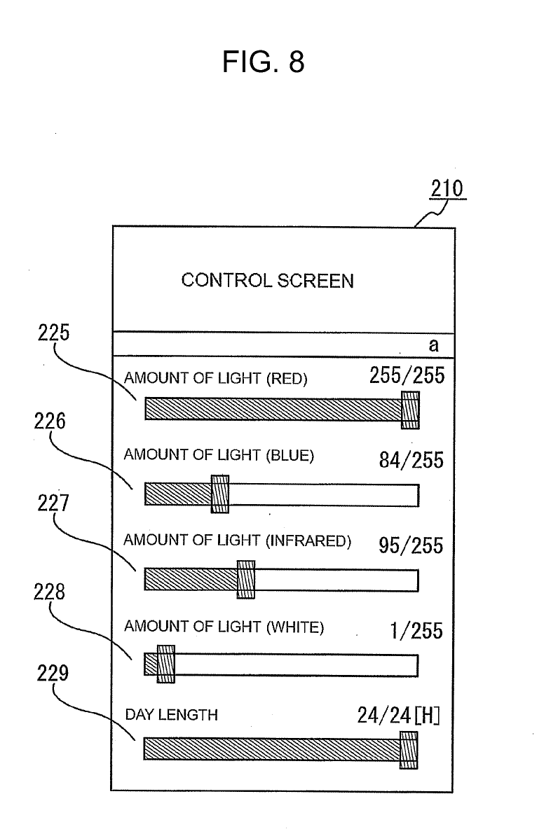

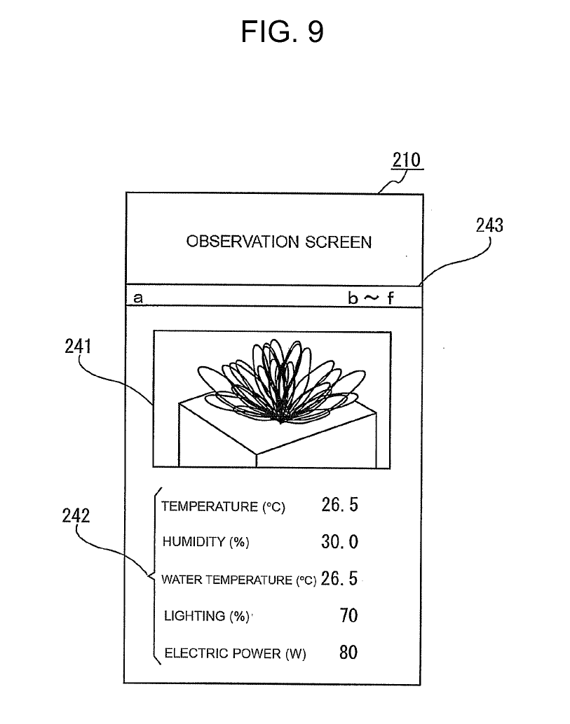

First, FIG. 6 is a flowchart showing an example of control of the cultivation system 100. In addition, FIG. 7 is a schematic diagram showing an example of the display screen 210 of the portable communication terminal 200, FIG. 8 is a schematic diagram showing another example of the display screen 210 of the portable communication terminal 200, and FIG. 9 is a schematic diagram showing still another example of the display screen 210 of the portable communication terminal 200.

First, as shown in FIG. 6, when the app on the display screen 210 of the portable communication terminal 200 is operated by the user, a control screen is displayed on the display screen (step S1).

As shown in FIG. 6, the portable communication terminal 200 provides a result of an operation performed on the control screen, i.e., a control instruction, to the cultivation apparatus 300 through the cloud 500 (step S2). The cultivation apparatus 300 receives the instruction from the portable communication terminal 200 (step S3). According to the control instruction, the cultivation apparatus 300 activates various types of devices, i.e., the lighting apparatuses 320, the imaging apparatuses 330, the environment control apparatuses 350, and the fertilizer supply control apparatuses 360. As a result, the various types of devices are controlled (step S4).

Now, a specific example of the processes at steps S1 to S4 will be described. For example, as shown in FIG. 8, when cultivation control of the inside of the cultivation cell 340a of the cultivation apparatus 300 is performed by light control, the light control is performed by setting the irradiation conditions of the lighting apparatus 320a to specific adjustment values. In this case, an adjustment of the red LEDs 325 is performed by an adjusting unit 225, an adjustment of the blue LEDs 326 is performed by an adjusting unit 226, an adjustment of the infrared LEDs 327 is performed by an adjusting unit 227, an adjustment of the white LEDs 328 is performed by an adjusting unit 228, and one day irradiation time is performed by an adjusting unit 229.

On the other hand, when cultivation control of the inside of the cultivation cell 340b of the cultivation apparatus 300 is performed by light control, the light control is performed by setting the irradiation conditions of the lighting apparatus 320b to specific adjustment values that are different from those of the lighting apparatus 320a.

As such, light control is performed on the cultivation cell 340a and the cultivation cell 340b independently of each other.

In addition, for example, as shown in FIG. 7, when cultivation control of the inside of the cultivation cell 340c of the cultivation apparatus 300 is performed by environment control and fertilizer supply control, each control is performed by setting the conditions of the environment control apparatus 350c and the fertilizer supply control apparatus 360c to specific adjustment values. In this case, an adjustment of temperature is performed by an adjusting unit 325, an adjustment of humidity is performed by an adjusting unit 326, an adjustment of water temperature is performed by an adjusting unit 327, an adjustment of nitrogen is performed by an adjusting unit 328, an adjustment of carbon dioxide is performed by an adjusting unit 329, an adjustment of oxygen is performed by an adjusting unit 330, an adjustment of air pressure is performed by an adjusting unit 331, and an adjustment of liquid fertilizer is performed by an adjusting unit 332.

On the other hand, when cultivation control of the inside of the cultivation cell 340d of the cultivation apparatus 300 is performed by environment control and fertilizer supply control, each control is performed by setting the conditions of the environment control apparatus 350d and the fertilizer supply control apparatus 360d to specific adjustment values that are different from those of the environment control apparatus 350c and the fertilizer supply control apparatus 360c.

As such, environment control and fertilizer supply control are performed on the cultivation cell 340c and the cultivation cell 340d independently of each other.

Note that in the present embodiment, in the settings of the lighting apparatus 320 on the display screen 210, the setting condition of each LED can be changed at 256 levels (0 to 255).

In addition, in the present embodiment, in the settings of the environment control apparatus 350c and the fertilizer supply control apparatus 360c on the display screen 210, the setting condition of each LED can be changed at 256 levels (0 to 255).

Furthermore, by changing display screens 210 for the lighting apparatuses 320a to 320f, the environment control apparatuses 350a to 320f, and the fertilizer supply control apparatuses 360a to 360f, these apparatuses can be individually controlled.

Then, as shown in FIG. 6, the cultivation apparatus 300 transmits to the cloud 500 growth history information including all of control instructions provided to the six cultivation cells 340a to 340f from the portable communication terminal 200, control instructions provided to the lighting apparatuses 320, image data captured by the imaging apparatuses 330, and various types of control information and operating information of the environment control apparatuses 350 and the fertilizer supply control apparatuses 360 (step S5), and records the growth history information in the recording apparatus 400 (step S6).

In addition, the cultivation apparatus 300 transmits the conditions which are controlled according to the control instructions from the portable communication terminal 200, to the portable communication terminal 200 (step S7).

The portable communication terminal 200 displays the conditions on the display screen 210 (step S8).

For example, as shown in FIG. 9, cultivation information of the cultivation cell 340a among the six cultivation cells 340a to 340f is displayed on the display screen 210 of the portable communication terminal 200. On the display screen 210 of FIG. 9, plant image data 241 at the top and the current measured numerical values 242 of the environment control apparatus 350 are displayed. By this, a plant in the cultivation cell 340a can be observed. In addition, by the user touching a portion 243 on the display screen 210, the user can change the cultivation information to cultivation information of any one of the other cultivation cells 340b to 340f.

In addition, by the user touching the image data 241, image data for the last one day, the last one week, and the last one month is continuously displayed, by which the user can observe the plant as if the plant were growing in a short period of time. In addition, when the image data 241 is a moving image, fast-forward playback, pause playback, and the like can be selected.

Finally, as shown in FIG. 6, it is determined whether the app 700 on the portable communication terminal 200 has ended (step S9). If it is determined that the app 700 has not ended, processing is repeated again from the process at step S1. On the other hand, if it is determined that the app 700 has ended, processing ends.

Note that in the present embodiment, only the conditions are transmitted to the portable communication terminal 200, the reason for which is because providing a large amount of growth history information of the cultivation apparatus 300 to the portable communication terminal 200 takes time to perform processing. Note that, when the portable communication terminal 200 has high throughput and large capacity, the portable communication terminal 200 may be allowed to transmit and receive all growth history information which is the same as that in the recording apparatus 400.

In addition, although recording is performed on the recording apparatus 400 from the cultivation apparatus 300, the configuration is not limited thereto. The recording apparatus 400 may include a control unit and actively obtain and record growth history information transmitted from the cultivation apparatus 300.

Furthermore, although the display of cultivation information of FIG. 9 is performed using the measured numerical values 242 of the cultivation conditions, the display is not limited to this mode. For example, the display of cultivation information may be performed by presenting the measured numerical values in graphical form. As a result, the user can easily recognize changes in environment.

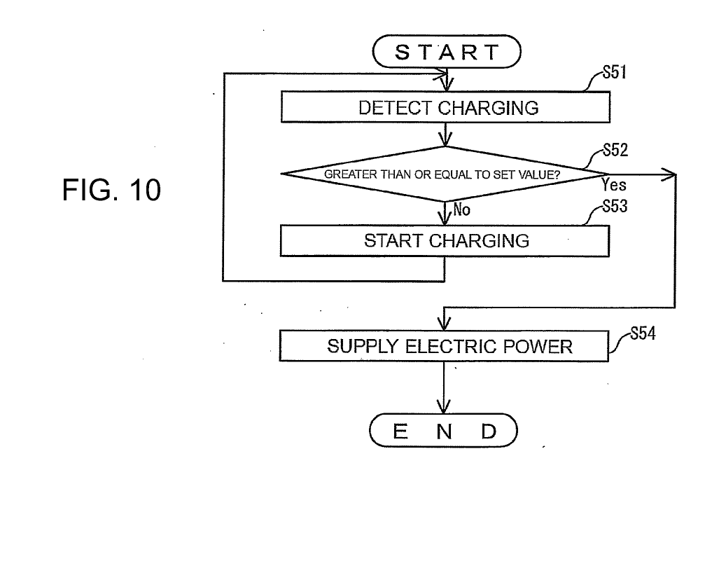

Next, the biomass power generating apparatus 380 and the notification apparatus 390 will be described. FIG. 10 is a flowchart showing an example of the operation of the biomass power generating apparatus 380.

As shown in FIG. 10, the biomass power generating apparatus 380 detects the amount of charging (step S51). Then, it is determined whether the amount of charging of the biomass power generating apparatus 380 is greater than or equal to a setting (step S52).

If the amount of charging of the biomass power generating apparatus 380 is less than the set value (No at step S52), charging starts (step S53).

On the other hand, if the amount of charging of the biomass power generating apparatus 380 is greater than or equal to the set value (Yes at step S52), electric power is supplied to each apparatus (step S54), and processing ends.

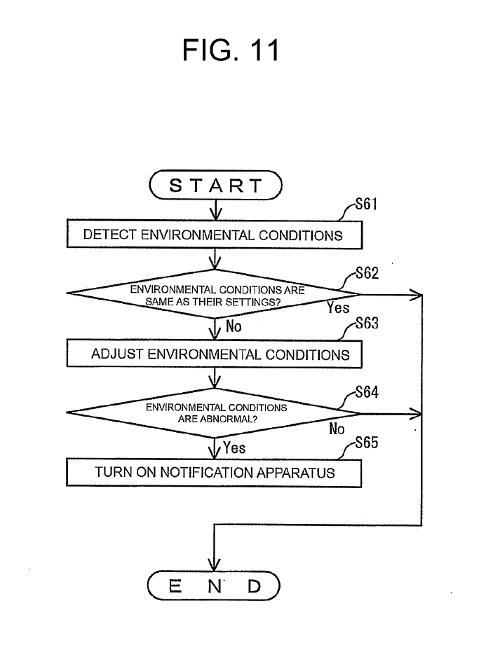

Next, FIG. 11 is a flowchart showing an example of the operation of the environment control apparatus 350.

As shown in FIG. 11, the environment control apparatus 350 detects environmental conditions (step S61). Then, the environment control apparatus 350 determines, for a corresponding one of the six shielded spaces, whether the environmental conditions are the same as their settings (step S62).

If it is determined that the environmental conditions are the same as their settings (Yes at step S62), processing ends. On the other hand, if it is determined that the environmental conditions are not the same as their settings (No at step S62), the environmental conditions are adjusted (step S63).

It is determined again whether the environmental conditions are the same as their settings (step S64). If it is determined that the environmental conditions are abnormal (Yes at step S64), the notification apparatus provides notification (step S65).

On the other hand, if it is determined that the environmental conditions are normal (No at step S64), processing ends.

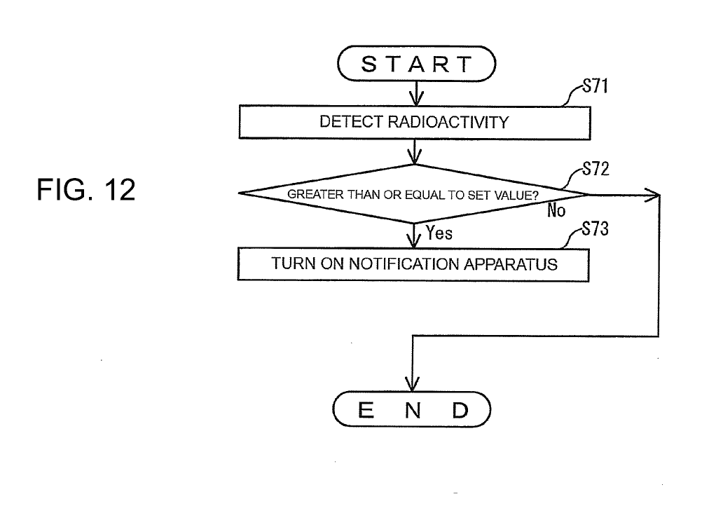

Next, FIG. 12 is a flowchart showing an example of the operation of the radioactivity detection apparatus 370.

As shown in FIG. 12, the radioactivity detection apparatus 370 detects radioactivity (step S71). Then, it is determined whether the radioactivity detection apparatus 370 is greater than or equal to a set value (step S72).

If the radioactivity detection apparatus 370 is less than the set value (No at step S72), processing ends.

If the radioactivity detection apparatus 370 is greater than or equal to the set value (Yes at step S72), the notification apparatus 390 provides notification (step S73).

As described above, in the cultivation system 100, the cultivation program, and the cultivation method according to the present invention, by means of the portable communication terminal 200, the user can grow a plant in a specific partitioned space among a plurality of shielded spaces provided in the cultivation apparatus 300 present at a distant location.

In addition, by adjusting carbon dioxide, the amount of liquid fertilizer, humidity and temperature, and the dominant wavelength and brightness level of light from the lighting apparatus in each of the plurality of shielded spaces, the rates of photosynthesis and respiration of a plant can be adjusted.

Furthermore, the influence of radioactive materials can be monitored by the radioactivity detection apparatus 370, enabling to easily know whether a plant to be cultivated is contaminated with radioactive materials.

In addition, biomass in an external environment can be effectively used as an electric power source by recycling. Furthermore, by passing through a cloud, multiple control instructions can be easily processed. Furthermore, since notification is provided by the notification apparatus 390 when the growth conditions deviate, an abnormal state can be easily recognized.

### [Correspondence Relationship Between Units of Embodiment and Other Examples and Constituent Elements of Claims]

In the present invention, the cultivation cells 340a to 340f correspond to a plurality of shielded spaces, the environment control apparatuses 350a to 350f correspond to environment control apparatuses, the cultivation apparatus 300 corresponds to a cultivation apparatus, the communication terminal apparatus 200 corresponds to a communication terminal, the cultivation system 100 corresponds to a cultivation control system, the carbon dioxide tank 351 corresponds to a carbon dioxide storage tank, the liquid fertilizer storage tank 361 corresponds to a liquid fertilizer storage tank, the lighting apparatuses 320a to 320f correspond to lighting apparatuses, the radioactivity detection apparatus 370 corresponds to a dosimeter, the notification apparatus 390 corresponds to a notification apparatus, the recording apparatus 400 corresponds to a recording apparatus, the biomass power generating apparatus 380 corresponds to an electric power receiving apparatus, and the cloud 500 corresponds to a cloud.

The preferred embodiments of the present invention are as described above, but the present invention is not limited thereto. Various other embodiments may be performed without departing from the spirit of the present invention. Furthermore, although in the embodiments the functions and effects brought about by the configuration of the present invention are described, the functions and effects are an example and thus do not limit the present invention.

1. A cultivation control system comprising:
a cultivation apparatus having a plurality of shielded spaces for growing plants, and environment control apparatuses for controlling growth conditions in internal environments of the shielded spaces; and
a communication terminal that performs remote control of the environment control apparatuses such that at least one of the internal environments of the plurality of shielded spaces is independently controlled, wherein
each of the internal environments of the plurality of shielded spaces is shielded from an internal environment of a shielded space adjacent thereto and from an external environment of the cultivation apparatus.

2. The cultivation control system according to claim 1, wherein the growth conditions to be controlled is a concentration of carbon dioxide.

3. The cultivation control system according to claim 2, wherein the environment control apparatuses control at least one of pressure and a flow rate from a carbon dioxide storage tank that stores carbon dioxide emitted from a carbon dioxide emitting source in the external environment.

4. The cultivation control system according to claim 1, wherein the growth conditions to be controlled is at least one of an amount and a composition of liquid fertilizer.

5. The cultivation control system according to claim 4, wherein the environment control apparatuses control at least one of pressure and a flow rate from a liquid fertilizer storage tank that stores biogas liquid fertilizer derived from biomass in the external environment.

6. The cultivation control system according to claim 1, wherein the growth conditions to be controlled is at least one of humidity and temperature, and the environment control apparatuses are air conditioners.

7. The cultivation control system according to claim 1, wherein the environment control apparatuses are lighting apparatuses, and the growth conditions to be controlled is at least one of dominant wavelength and brightness level of a light from the lighting apparatuses.

8. The cultivation control system according to claim 7, wherein the lighting apparatuses include a light source of at least one of a light-emitting diode element and an organic electroluminescent element.

9. The cultivation control system according to claim 7, wherein
the lighting apparatuses each include:
a plurality of types of light sources that emit light of different dominant wavelengths; and
a plurality of boards having the plurality of types of light sources provided thereon, and
each of the boards is extendable by being coupled to the other one of the boards.

10. The cultivation control system according to claim 1, wherein the growth conditions to be controlled is at least one of a concentration of nitrogen, a concentration of oxygen, liquid pressure, gas pressure, a liquid flow, and a gas flow.

11. The cultivation control system according to claim 1, further comprising a dosimeter that measures a dose of a radioactive material in the internal environments or at a part that can contact or communicate with the internal environments.

12. The cultivation control system according to claim 11, further comprising at least one of a notification apparatus that provides notification when the dose of the radioactive material exceeds a threshold value, and a recording apparatus that records the dose.

13. The cultivation control system according to claim 1, further comprising an electric power receiving apparatus that receives electric power from a biomass power generating apparatus, using biomass in the external environment.

14. The cultivation control system according to claim 1, wherein the remote control is performed through a cloud.

15. The cultivation control system according to claim 1, further comprising a notification apparatus that provides notification when any of the growth conditions deviates from a reference range.

16. The cultivation control system according to claim 1, further comprising a recording apparatus for recording the growth conditions.

17. A cultivation control program comprising:
an environment control process that controls growth conditions of plants in internal environments of a plurality of shielded spaces; and
a remote control process that independently controls the environment control process for at least one of the internal environments of the plurality of shielded spaces.

18. The cultivation control program according to claim 17, wherein the environment control process further includes a carbon dioxide control procedure that controls one of pressure and a flow rate from a carbon dioxide storage tank that stores carbon dioxide emitted from a carbon dioxide emitting source in the external environment.

19. The cultivation control program according to claim 17, wherein the environment control process further includes a liquid fertilizer control process that controls one of pressure and a flow rate from a liquid fertilizer storage tank that stores biogas liquid fertilizer derived from biomass in the external environment.

20. The cultivation control program according to claim 17, wherein the environment control process further includes an air-conditioning process that controls at least one of humidity and temperature.

21. The cultivation control program according to claim 17, wherein the environment control process further includes a lighting control process that controls lighting apparatuses.

22. The cultivation control program according to claim 17, wherein the environment control process controls at least one of a concentration of nitrogen, a concentration of oxygen, liquid pressure, gas pressure, a liquid flow, and a gas flow.

23. The cultivation control program according to claim 17, further comprising a recording process for recording the controlled growth conditions.

24. A cultivation control method comprising:
an environment controlling step of controlling growth conditions of plants in internal environments of a plurality of shielded spaces; and
a remote controlling step of independently controlling the environment controlling step for at least one of the internal environments of the plurality of shielded spaces.

25. The cultivation control method according to claim 24, wherein the environment controlling step further includes a carbon dioxide controlling step of controlling one of pressure and a flow rate from a carbon dioxide storage tank that stores carbon dioxide emitted from a carbon dioxide emitting source in the external environment.

26. The cultivation control method according to claim 24, wherein the environment controlling step further includes a liquid fertilizer controlling step of controlling one of pressure and a flow rate from a liquid fertilizer storage tank that stores biogas liquid fertilizer derived from biomass in the external environment.

27. The cultivation control method according to claim 24, wherein the environment controlling step further includes an air-conditioning step of controlling at least one of humidity and temperature.

28. The cultivation control method according to claim 24, wherein the environment controlling step further includes a lighting controlling step of controlling lighting apparatuses.

29. The cultivation control method according to claim 24, wherein in the environment controlling step, at least one of a concentration of nitrogen, a concentration of oxygen, liquid pressure, gas pressure, a liquid flow, and a gas flow is controlled.

30. The cultivation control method according to claim 24, further comprising a recording step of recording the controlled growth conditions.
